(19) United States
(12) Patent Application Publication
(10) Pub. No.: US 2019/0033771 A1
(43) Pub. Date: Jan. 31, 2019

(54) IMAGE FORMING APPARATUS

(71) Applicant: Konica Minolta, Inc., Tokyo (JP)

(72) Inventors: Katsuhide SAKAI, Toyokawa-shi (JP); Yasuhiro ISHIHARA, Toyohashi-shi (JP); Satoshi CHIKAZAWA, Toyokawa-shi (JP)

(21) Appl. No.: 16/025,792

(22) Filed: Jul. 2, 2018

(30) Foreign Application Priority Data
Jul. 25, 2017 (JP) 2017-143280

(51) Int. Cl. G03G 15/00

(52) U.S. Cl. CPC G03G 15/70; G03G 15/5029

(57) ABSTRACT

An image forming apparatus that conveys a sheet and forms an image on the sheet, the image forming apparatus includes: a plurality of rollers that are arranged at different positions from one another in a conveyance path of the sheet, and convey the sheet; a motor that rotationally drives at least one of the rollers; a drive that drives the motor by applying a current to the motor; and a hardware processor that determines whether a jam has occurred and a jam type, in accordance with a change in the current flowing in the motor in a period during which the sheet is expected to pass through a target roller being rotationally driven by the motor among the rollers.

The entire disclosure of Japanese patent Application No. 2017-143280, filed on Jul. 25, 2017, is incorporated herein by reference in its entirety.

### BACKGROUND

### Technological Field

The present invention relates to an image forming apparatus.

### Description of the Related Art

An image forming apparatus such as a printer, a copying machine, and a multifunction peripheral takes out and conveys a sheet (a recording paper sheet) from a storage unit, and prints an image on the sheet being conveyed at a predetermined position. A plurality of rollers are disposed at shorter intervals than the length of the sheet in the conveyance path inside the image forming apparatus, and the image forming apparatus controls rotational driving of the rollers so that the sheet passes through each position in the conveyance path at a predetermined time.

A jam sometimes occurs in the conveyance path, as a paper sheet is stuck in the conveyance path. To detect a jam, sheet sensors that optically detect the presence/absence of a sheet are normally disposed at a plurality of positions in the conveyance path. When a sheet is not detected even after the time at which the sheet should arrive at the position of a sensor, or a sheet is still detected even after the time at which the sheet should have finished passing through the position of a sensor, it is determined that a jam has occurred.

When a jam is detected, the image forming apparatus immediately stops the sheet conveyance, and suspends execution of the print job. The image forming apparatus then causes the display of the operation panel to display a message prompting the user to remove the sheet(s) remaining in the conveyance path.

JP 2007-298964 A discloses a technique in which a winding jam is detected with two sheet sensors, and, when a winding jam occurs, the motor is stopped by a method with a higher stopping ability than in a case where another kind of jam occurs.

Examples of conventional techniques for detecting jams without sheet sensors includes the techniques disclosed in JP 9-236958 A and JP 2013-209220 A.

JP 9-236958 A discloses an electrophotographic image forming apparatus in which a torque sensor is provided between a roller in a fixing unit and a motor for driving the roller, and, when the rotation torque of the motor exceeds a reference torque, it is determined that a jam has occurred.

JP 2013-209220 A discloses a technique that involves means to calculate the drive torque of a motor from a drive voltage input to the motor that drives a roller, and means to estimate the time at which a sheet passes through the roller, so that a jam is detected in accordance with the calculated drive torque at the estimated time.

Processes to be performed by an image forming apparatus when a jam occurs at one of the possible positions in the conveyance path can be switched in accordance with a jam type. For example, the user is notified of the jam type as well as the jam occurrence position, so that the process of removing the remaining sheet(s) is facilitated.

Also, the types of jams that have occurred can be recorded together with occurrence positions, so that the records become useful in diagnosis of the condition of the image forming apparatus, maintenance by the maintenance personnel, future product development, and the like.

The techniques disclosed in JP 9-236958 A and JP 2013-209220 A are designed for detecting whether a jam has occurred and are not designed for performing various processes in accordance with jam types. Particularly, the technique disclosed in JP 9-236958 A involves a torque sensor, and therefore, it is difficult to lower the component cost.

The technique disclosed in JP 2007-298964 A is to switch processes depending on whether the jam in the fixing unit is a winding jam or some other jam. However, two sheet sensors are used in distinguishing a winding jam from other jams. Therefore, it is difficult to lower the component cost. Further, in a case where a jam occurrence position is to be identified from among rollers including rollers other than the roller in the fixing unit, two sheet sensors need to be prepared for each of the rollers, and therefore, the number of sensor components increases to a very large number.

To reduce the size and the cost of an image forming apparatus, there is also a demand for a smaller number of sensor components these days.

### SUMMARY

The present invention has been made in view of the above problems, and an object thereof is to determine whether a jam has occurred and a jam type at the position of a roller not provided with any sensor component, and thus reduce the size and the cost of the apparatus.

To achieve the abovementioned object, according to an aspect of the present invention, an image forming apparatus that conveys a sheet and forms an image on the sheet, reflecting one aspect of the present invention comprises: a plurality of rollers that are arranged at different positions from one another in a conveyance path of the sheet, and convey the sheet; a motor that rotationally drives at least one of the rollers; a drive that drives the motor by applying a current to the motor; and a hardware processor that determines whether a jam has occurred and a jam type, in accordance with a change in the current flowing in the motor in a period during which the sheet is expected to pass through a target roller being rotationally driven by the motor among the rollers.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing an example structure of an image forming apparatus according to an embodiment of the present invention;

FIG. 2 is a diagram showing the rollers that convey sheets and the drive source for the rollers;

FIGS. 3A through 3D are diagrams showing examples of jams;

FIGS. 4A and 4B are diagrams showing an example structure of a motor and a d-q axis model of the motor;

FIG. 5 is a diagram showing a functional configuration of the relevant components relating to driving of and control on the motors in the image forming apparatus;

FIG. 6 is a diagram showing an example configuration of a vector controller;

FIG. 7 is a chart showing an example of transition of the rotation torque of a motor during normal conveyance;

FIG. 8 is a chart showing an example of determination as to whether a jam has occurred and jam types;

FIGS. 9A and 9B are charts showing examples of determination as to whether a jam has occurred and jam types;

FIG. 10 is a chart showing torque calculation error in continuous rotation;

FIG. 11 is a chart showing the periods during which the motor current is measured in a case where speed is adjusted during conveyance; and

FIG. 12 is a chart showing the flow in a jam determination process in the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

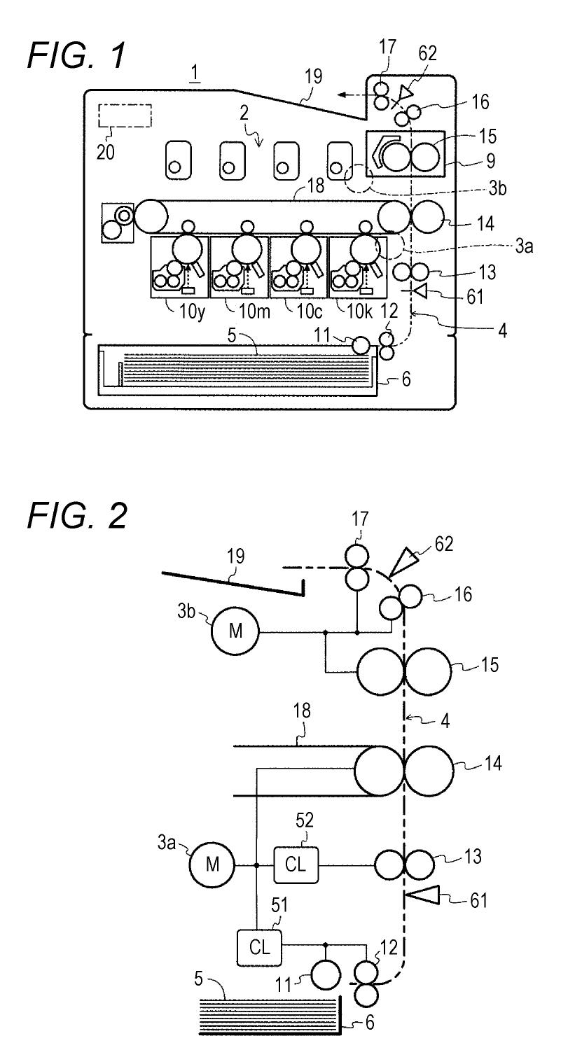

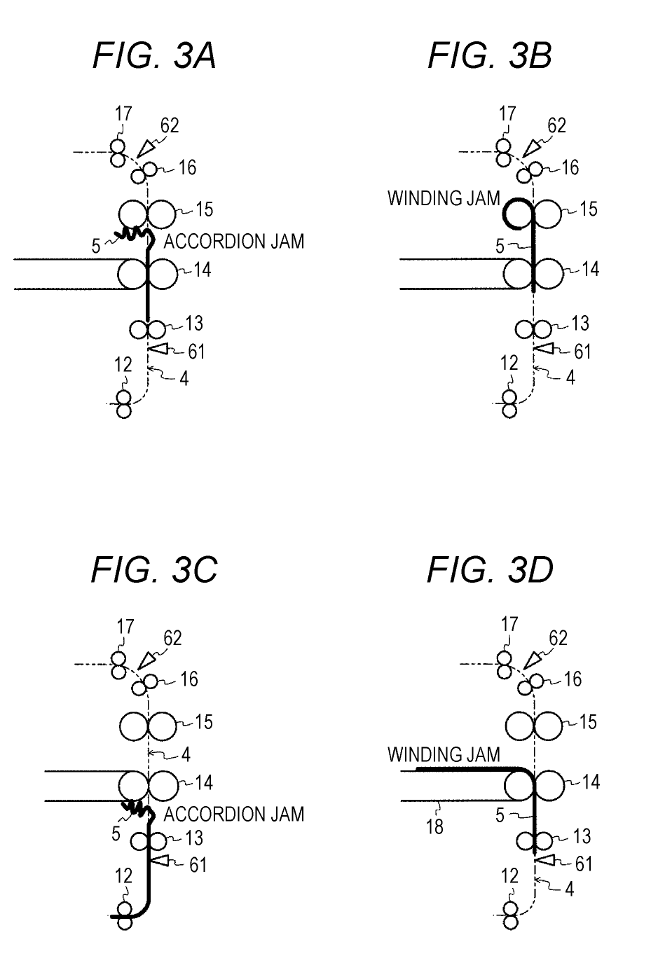

FIG. 1 shows a schematic configuration of an image forming apparatus 1 according to an embodiment of the present invention. FIG. 2 shows a group of rollers for conveying sheets 5 and a drive source for the rollers. FIGS. 3A through 3D each show an example of a jam.

In FIG. 1, the image forming apparatus 1 is a color printer including an electrophotographic printer engine 2. The printer engine 2 has four imaging stations 10y, 10m, 10c, and 10k arranged in the horizontal direction. Each of the imaging stations 10y through 10k has a tubular photoreceptor, a charger, a developing device, a cleaner, a light source for exposure, and the like.

In a color print mode, the four imaging stations 10y through 10k form toner images in the four colors Y (yellow), M (magenta), C (cyan), and K (black) in parallel. The four-color toner images are sequentially transferred in a primary transfer process onto an intermediate transfer belt 18 that is rotating. The Y toner image is first transferred, and the M toner image, the C toner image, and the K toner image are sequentially transferred onto the Y toner image.

When the toner images transferred by the primary transfer face a secondary transfer roller 14, the toner images are transferred in a secondary transfer process onto a sheet (a recording paper sheet) 5 that has been taken out from a lower storage cassette 6 and been conveyed. After the secondary transfer, the sheet 5 is sent to an upper sheet catch tray 19 through the inside of a fixing unit 9. When the sheet 5 passes through the fixing unit 9, the toner images are fixed to the sheet 5 by heating and pressure.

Referring now to FIG. 2, a pickup roller 11, sheet feed rollers 12, registration rollers 13, secondary transfer rollers 14, fixing rollers 15, first sheet discharge rollers 16, and second sheet discharge rollers 17 are arranged in this order from the upstream side in a conveyance path 4 that is the passage of the sheets 5 inside the image forming apparatus 1. As these rollers 11 through 17 rotate, the sheets 5 are conveyed.

The pickup roller 11 takes out the uppermost sheet 5 of the sheets 5 stacked in the storage cassette 6. The sheet feed rollers 12 send the taken-out sheet 5 to the registration rollers 13. The sheet feed rollers 12 have a loosening function to allow only one sheet to pass therethrough when two or more stacked sheets 5 are taken out.

The registration rollers 13 are rollers for aligning (registering) a sheet 5 with an image and correcting skew of a sheet 5. The registration rollers 13 stay still at the arrival of a sheet 5, and is activated at the time of alignment of the sheet 5 with the toner image transferred by primary transfer onto the intermediate transfer belt 18, to send the sheet 5 to the secondary transfer rollers 14.

The conveyance by the sheet feed rollers 12 is continued for a while after the arrival of the sheet 5 at the registration rollers 13 in a resting state. Because of this, the sheet 5 is pressed against the registration rollers 13, and its top edge becomes parallel to the rotation axes of the registration rollers 13. That is, skew is eliminated.

A registration sensor 61 for detecting the presence or absence of a sheet 5 is disposed near the upstream side of the registration rollers 13. In accordance with the time at which the registration sensor 61 detects the sheet 5, the time to stop the sheet feed rollers 12 and the time to activate the registration rollers 13 are adjusted.

The secondary transfer rollers 14 bring the sheet 5 into close contact with the intermediate transfer belt 18. The fixing rollers 15 is a pair of rollers provided in the fixing unit 9, and applies heat and pressure to the sheet 5. The first sheet discharge rollers 16 and the second sheet discharge rollers 17 send the sheet 5 after the fixing to the sheet catch tray 19.

A sheet discharge sensor 62 for detecting the presence or absence of a sheet 5 is disposed between the first sheet discharge rollers 16 and the second sheet discharge rollers 17. An output of the sheet discharge sensor 62 is used in detecting passage of a sheet 5 to count the number of discharged sheets, for example.

Contact-type sensors can be used as the registration sensor 61 and the sheet discharge sensor 62. A contact-type sensor may be formed with an actuator that is pushed and displaced by a sheet 5 and returns to the original position when no longer being pushed, and an interrupter that detects the displacement. Generally, a contact-type sensor is more inexpensive than a noncontact-type sensor such as a reflective photosensor.

As shown in FIG. 2, the pickup roller 11, the sheet feed rollers 12, the registration rollers 13, the secondary transfer rollers 14, and the intermediate transfer belt 18 are rotationally driven by a main motor 3a that is a drive source shared among these components. The rotary drive force of the main motor 3a is transmitted to the pickup roller 11 and the sheet feed rollers 12 via a clutch 51, and to the registration rollers 13 via a clutch 52. As the clutches 51 and 52 are switched on and off, revolutions and stops of these rollers are controlled independently of control on the intermediate transfer belt 18.

Meanwhile, the fixing rollers 15, the first sheet discharge rollers 16, and the second sheet discharge rollers 17 are rotationally driven by a fixing motor 3b that is a drive source shared among these components.

In the description below, the main motor 3a and/or the fixing motor 3b will be sometimes referred to as the “motor 3” without being distinguished from each other.

It should be noted that, in the image forming apparatus 1, any sheet sensor is not disposed in the vicinities of the secondary transfer rollers 14 and the fixing rollers 15. However, as shown in FIGS. 3A through 3D, a jam might occur at the position of these rollers, depending on the state of a sheet 5.

In FIG. 3A, an accordion jam occurs as a sheet 5 does not enter the nip portion between the fixing rollers 15 but jams before the nip portion. In FIG. 3B, after the top edge of a sheet 5 comes out of the nip portion between the fixing rollers 15, a winding jam occurs as the sheet 5 winds around a fixing roller 15 due to a factor such as curling. In FIG. 3C, an accordion jam occurs as a sheet 5 jams before the secondary transfer rollers 14. In FIG. 3D, a winding jam occurs as a sheet 5 that has passed through the secondary transfer position winds around the intermediate transfer belt 18. A sheet 5 might wind around a secondary transfer roller 14.

The image forming apparatus 1 has a function of determining whether a jam has occurred in a zone not provided with any sheet sensor in the conveyance path 4, the occurrence position, and the jam type, in accordance with the state of the motor 3 relating to the conveyance in the zone. In the description below, this function is mainly explained in conjunction with the configuration and operation of the image forming apparatus 1.

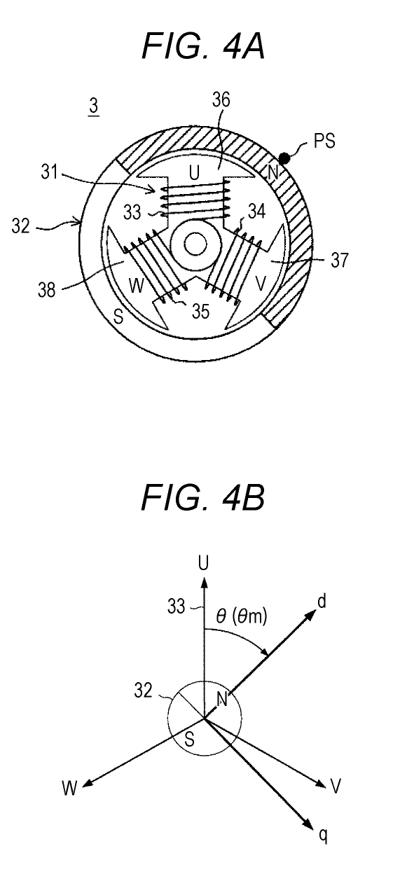

FIGS. 4A and 4B show an example structure of the motor 3, and a d-q axis model of the motor 3.

The motor 3 is a sensorless permanent magnet synchronous motor (PMSM). The motor 3 includes a stator 31 as an armature that generates a rotating magnetic field, and a rotor 32 formed with a permanent magnet. The stator 31 includes U-, V-, and W-phase cores 36, 37, and 38 arranged at intervals of 120 electrical degrees, and three Y-connected windings (coils) 33, 34, and 35. The three-phase alternating current of the U-, V-, and W-phases is applied to the windings 33 through 35, to sequentially excite the cores 36, 37, and 38. In this manner, a rotating magnetic field is generated. The rotor 32 rotates in synchronization with this rotating magnetic field.

In the example shown in FIG. 4A, the number of the magnetic poles of the rotor 32 is two. However, the number of the magnetic poles of the rotor 32 is not necessarily two, and may be four, six, or greater. The rotor 32 may be of either an outer type or an inner type. Also, the number of the slots of the stator 31 is not necessarily three. In any case, vector control (sensorless vector control) for estimating magnetic pole positions and a rotation speed is performed by later described vector controllers 25 on the motor 3 with a control model based on a d-q coordinate system.

In the description below, the rotation angle position of the north pole indicated by a black circle between the south pole and north pole of the rotor 32 will be sometimes referred to as the “magnetic pole position PS” of the rotor 32.

In the vector control on the motor 3, the three-phase alternating current flowing in the windings 33 through 35 of the motor 3 is converted into a direct current to be applied to the two-phase windings rotating in synchronization with the permanent magnet serving as the rotor 32. Thus, the control operation is simplified.

As shown in FIG. 4B, the magnetic flux direction (the direction of the north pole) of the permanent magnet is the d-axis, and the direction that is advanced π/2 [rad] (90 degrees) in electrical angle from the d-axis is the q-axis. The d-axis and the q-axis are model axes. With the U-phase winding 33 being the reference, the lead angle of the d-axis with respect to the winding 33 is defined as θ. This angle θ indicates the angular position (the magnetic pole position PS) of the magnetic pole with respect to the U-phase winding 33. The d-q coordinate system is located at a position advanced the angle θ from the U-phase winding 33 as the reference.

Since the motor 3 does not have any position sensor that detects the angular position (the magnetic pole position) of the rotor 32, the vector controllers 25 estimate the magnetic pole position PS of the rotor 32, or the angle θ, and control revolutions of the rotor 32 using an estimated angle θm that is the estimated angle θ.

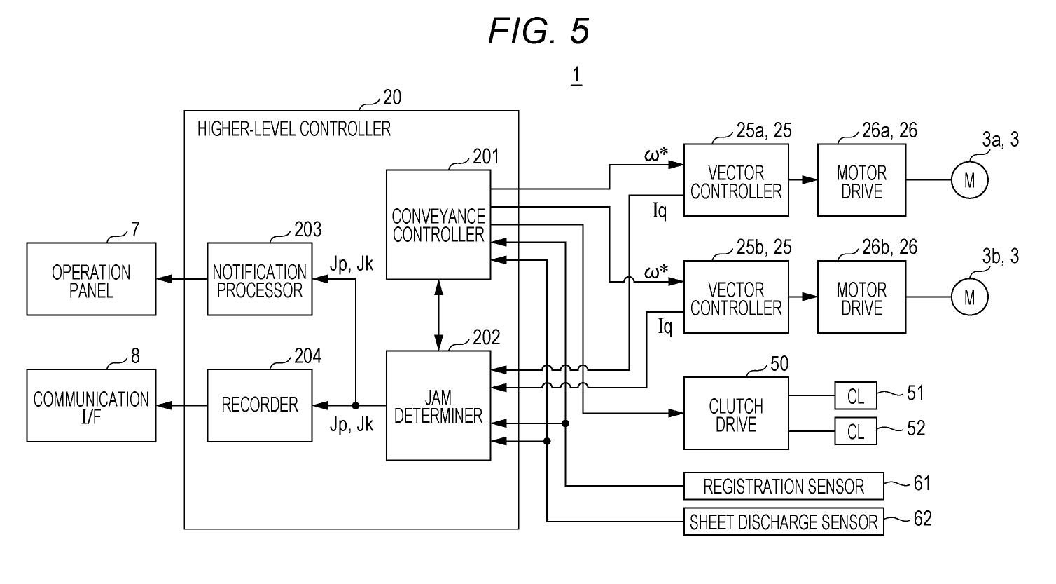

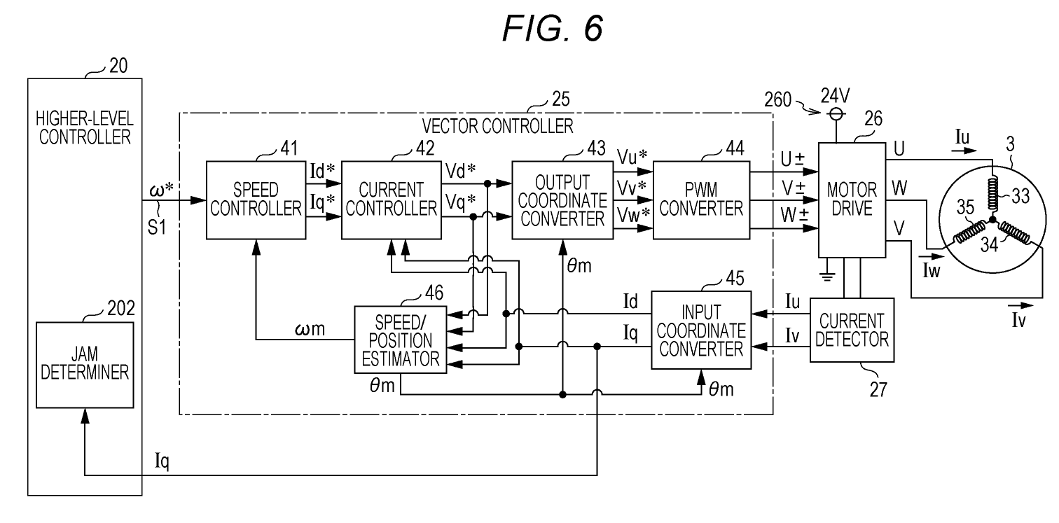

FIG. 5 shows the functional configuration of essential components relating to the drive of and the control on the motor 3 in the image forming apparatus 1. FIG. 6 shows an example configuration of a vector controller 25.

In FIG. 5, the image forming apparatus 1 includes motor drives 26a and 26b, vector controllers 25a and 25b, a higher-level controller 20, a clutch drive 50, an operation panel 7, a communication interface 8, and the like.

The motor drive 26a drives the main motor 3a by applying a current to the main motor 3a, and the motor drive 26b drives the fixing motor 3b by applying a current to the fixing motor 3b. The vector controller 25a performs vector control on the motor drive 26a, and the vector controller 25b performs vector control on the motor drive 26b. In the description below, each of the motor drives 26a and 26b will be sometimes referred to as the “motor drive 26” without being distinguished from each other, and each of the vector controllers 25a and 25b will be sometimes referred to as the “vector controller 25” without being distinguished from each other.

The higher-level controller 20 is a controller that is responsible for overall control in the image forming apparatus 1. The higher-level controller 20 includes a conveyance controller 201, a jam determiner 202, a notification processor 203, a recorder 204, and the like. These functions are achieved by the hardware configuration of the higher-level controller 20 including a central processing unit (CPU) and its peripheral devices, and by a control program being executed by the CPU.

The conveyance controller 201 controls conveyance of the sheet 5 in a print job. The conveyance controller 201 provides the vector controllers 25 with a target speed ω* corresponding to the operation pattern of the motor 3. The conveyance controller 201 also monitors the progress of conveyance in accordance with signals from the registration sensor 61 and the sheet discharge sensor 62, and instructs the clutch drive 50 to connect/release each of the clutches 51 and 52 at an appropriate time.

The jam determiner 202 determines whether a jam has occurred at the position of the secondary transfer rollers 14 and the jam type, in accordance with a change in the current flowing in the main motor 3a during the period during which the sheet 5 is expected to pass through the secondary transfer rollers 14. The jam determiner 202 also determines whether a jam has occurred at the position of the fixing rollers 15 and the jam type, in accordance with a change in the current flowing in the fixing motor 3b during the period during which the sheet 5 is expected to pass through the fixing rollers 15. The secondary transfer rollers 14 and the fixing rollers 15 are examples of target rollers.

In the jam determiner 202, the active current (or the q-axis current) that is the current component causing a rotation torque in the motor 3 during the vector control on the motor 3 is regarded as the current flowing in the motor 3. In accordance with a change in the current, a check is made to determine whether a jam has occurred, and the jam type is determined. A q-axis current value Iq indicating the magnitude of the active current is input from each vector controller 25 to the jam determiner 202.

After determining that a jam has occurred, the jam determiner 202 immediately notifies the conveyance controller 201 of the determination result. Upon receiving the notification, the conveyance controller 201 stops the conveyance. When determining that a jam has occurred, the jam determiner 202 also notifies the notification processor 203 and the recorder 204 of the jam occurrence position Jp and the jam type Jk. In this embodiment, the occurrence position Jp indicated in the notification is the position of the secondary transfer rollers 14 or the position of the fixing rollers 15, and the jam type Jk indicated in the notification is an accordion jam or a winding jam.

Upon receiving the notification from the jam determiner 202, the notification processor 203 causes the display of the operation panel 7a to display a message prompting the user to remove the sheet(s) 5 remaining in the conveyance path 4. At this stage, the position or the zone corresponding to the occurrence position Jp indicated in the notification is displayed as the place where the sheet 5 remains, and the jam type Jk indicated in the notification is also displayed. In the case of a winding jam, a message prompting the user to request the maintenance personnel to remove the sheet 5 may be displayed.

The recorder 204 records the occurrence position Jp and the jam type Jk indicated in the notification as the operation history, together with the occurrence date and time of the jam. The maintenance personnel can capture the recorded data into the terminal device for maintenance via the communication interface 8. Alternatively, the recorder 204 may transmit the accumulated recorded data to the service center in a timely manner.

In FIG. 6, the vector controller 25 generates control signals U+, U−, V+, V−, W+, and W− to be supplied to the motor drive 26, in accordance with values detected by a current detector 27.

The motor drive 26 is an inverter circuit for driving a rotor by applying current to the windings 33 through 35 of the motor 3. The motor drive 26 turns on and off transistors in accordance with the control signals U+, U−, V+, V−, W+, and W− supplied from the vector controller 25, to control the current flowing from a DC power supply line 260 to a ground line via the windings 33 through 35. More specifically, the current Iu flowing in the winding 33 is controlled in accordance with the control signals U+ and U−, the current Iv flowing in the winding 34 is controlled in accordance with the control signals V+ and V−, and the current Iw flowing in the winding 35 is controlled in accordance with the control signals W+ and W−.

The current detector 27 detects the currents Iu and Iv flowing in the windings 33 and 34, respectively. Since Iu+Iv+Iw=0, the current Iw can be calculated from the values of the detected currents Iu and Iv. Alternatively, a W-phase current detector may be provided.

The current detector 27 performs A-D conversion by amplifying voltage drops caused by the shunt resistors inserted in the flow paths of the currents Iu and Iv, and outputs the obtained values as the detected values of the currents Iu and Iv. That is, two-shunt detection is performed. The resistance value of each shunt resistor is a small value on the order of 1/10Ω.

A speed command 51 indicating the target speed (a speed command value) ω* is input from the higher-level controller 20 to the vector controller 25.

The vector controller 25 includes a speed controller 41, a current controller 42, an output coordinate converter 43, a PWM converter 44, an input coordinate converter 45, and a speed/position estimator 46.

The speed controller 41 performs calculation for proportional-integral control (PI control) to bring the difference between the target speed ω* from the higher-level controller 20 and an estimated speed ωm from the speed/position estimator 46 to a value close to zero, and then determines current command values Id* and Iq* of the d-q coordinate system. An estimated speed ωm is periodically input. The speed controller 41 determines the current command values Id* and Iq* each time an estimated speed ωm is input.

The current controller 42 performs calculation for proportional-integral control so that the difference between the current command value Id* and an estimated current value (a d-axis current value) Id supplied from the input coordinate converter 45, and the difference from an estimated current value (a q-axis current value) Iq supplied from the input coordinate converter 45 like the current command value Iq* are brought to values close to zero. The current controller 42 then determines voltage command values Vd* and Vq* of the d-q coordinate system.

As the difference between the current command value Iq* and the q-axis current value Iq asymptotically approaches zero, the current command value Iq*, instead of the q-axis current value Iq, may be used as the current component for generating a rotation torque in the motor 3. That is, either the q-axis current value Iq or the current command value Iq* can be used as the active current indicating the torque of the motor 3. In other words, the q-axis current value Iq or the current command value Iq* is equivalent to the torque of the motor 3, and whether a jam has occurred and the jam type can be determined from a change in the q-axis current value Iq or the current command value Iq*. It is also possible to use a value other than the q-axis current value Iq and the current command value Iq*, as long as the value is equivalent to the torque of the motor 3.

In accordance with an estimated angle θm supplied from the speed/position estimator 46, the output coordinate converter 43 converts the voltage command values Vd* and Vq* into U-, V-, and W-phase voltage command values Vu*, Vv*, and Vw*. That is, voltage conversion from two phases to three phases is performed.

The PWM converter 44 generates a pattern of the control signals U+, U−, V+, V−, W+, and W− in accordance with the voltage command values Vu*, Vv*, and Vw*, and outputs the pattern to the motor drive 26. The control signals U+, U−, V+, V−, W+, and W− are signals for controlling the frequency and the amplitude of the three-phase AC power to be supplied to the motor 3, by pulse width modulation (PWM).

The input coordinate converter 45 calculates the value of the W-phase current Iw from the respective values of the U-phase current Iu and the V-phase current Iv detected by the current detector 27. In accordance with an estimated angle θm supplied from the speed/position estimator 46 and the values of the three-phase currents Iu, Iv, and Iw, the input coordinate converter 45 then calculates the d-axis current value Id and the q-axis current value Iq, which are estimated current values of the d-q coordinate system. That is, current conversion from three phases to two phases is performed. The d-axis current value Id and the q-axis current value Iq are input to the current controller 42 and the speed/position estimator 46. The q-axis current value Iq is also input to the jam determiner 202 of the higher-level controller 20.

In accordance with the estimated current values (Id and Iq) supplied from the input coordinate converter 45 and the voltage command values Vd* and Vq* supplied from the current controller 52, the speed/position estimator 46 calculates an estimated speed value ωm and an estimated angle θm according to a so-called voltage-current equation. The obtained estimated speed value ωm is input to the speed controller 41.

It should be noted that the configurations of the vector controller 25, the higher-level controller 20, and the like shown and described above are merely examples, and various other configurations can be adopted for performing vector control.

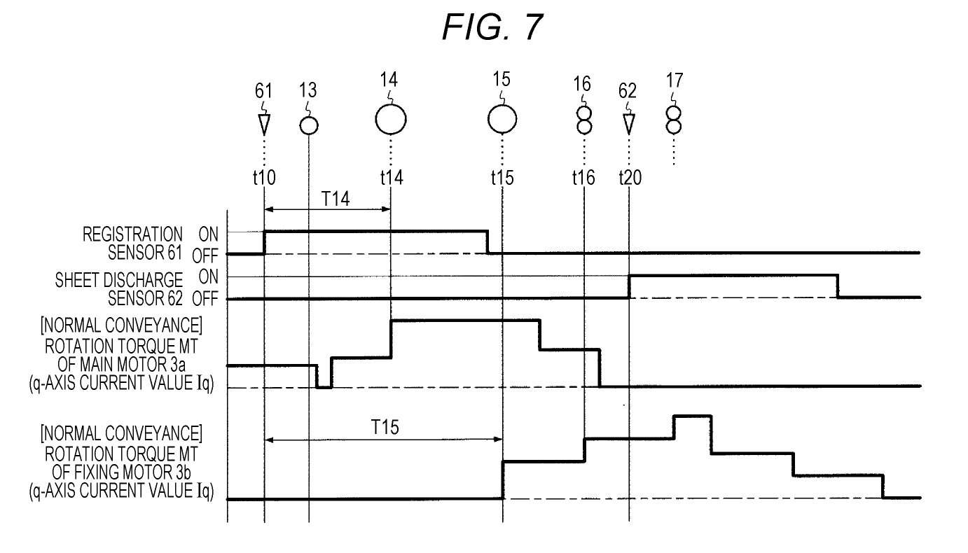

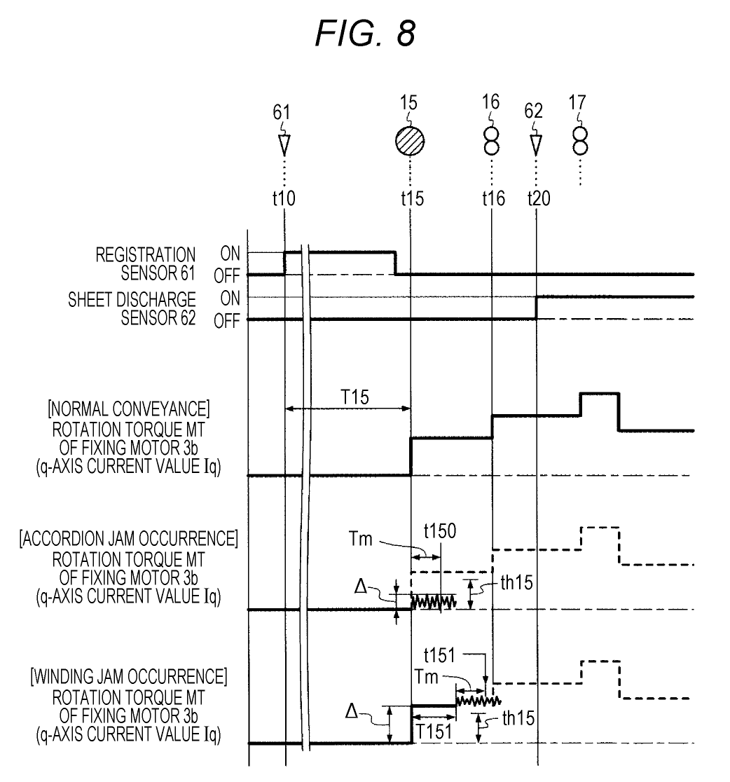

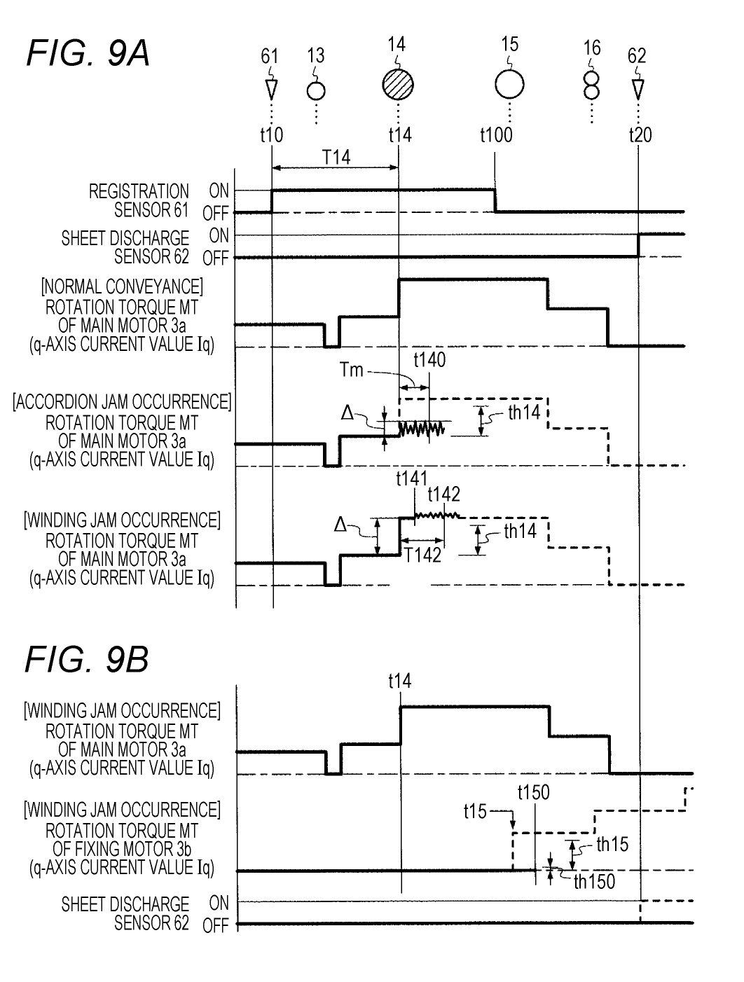

FIG. 7 shows an example of the transition of the rotation torque MT of the motor 3 during normal conveyance. FIG. 8 and FIGS. 9A and 9B each show an example of jam occurrence and jam type determination. The transition of the rotation torque MT of the motor 3 corresponds to the transition of the q-axis current value Iq.

When a sheet 5 is properly conveyed, the rotation torque MT of the motor 3 changes as shown in FIG. 7 as the conveyance progresses. This aspect is described below in detail.

In FIG. 7, when a sheet 5 arrives at the detection position of the registration sensor 61 (t10), the registration sensor 61 is switched from an OFF-state to an ON-state. At this point of time, the sheet 5 is being conveyed by the sheet feed rollers 12, and the rotation torque MT of the main motor 3a is the sum of the torque for driving the target (such as the intermediate transfer belt 18) other than the sheet feed rollers 12 and the torque for driving the sheet feed rollers 12. After that, when the sheet 5 has passed the detection position, the registration sensor 61 returns to an OFF-state.

When the sheet feed rollers 12 stop as the sheet 5 is appropriately pushed against the registration rollers 13 in a resting state, or, when the clutch 51 is turned off, the rotation torque MT of the main motor 3a temporarily drops. When the clutch 52 is turned on and the driving of the registration rollers 13 is started, the rotation torque MT of the main motor 3a rises. When the sheet 5 arrives at the secondary transfer rollers 14 (t14), the rotation torque MT of the main motor 3a further rises. After that, the rotation torque MT of the main motor 3a decreases while the sheet 5 is passing through the registration rollers 13, and further decreases when the sheet 5 has passes through the secondary transfer rollers 14.

On the other hand, the rotation torque MT of the fixing motor 3b rises when the sheet 5 arrives at the fixing rollers 15 (t15), and further increases when the sheet 5 arrives at the first sheet discharge rollers 16 (t16). After that, the rotation torque MT of the fixing motor 3b rises when the sheet 5 arrives at the second sheet discharge rollers 17, and drops in a stepwise manner as the sheet 5 sequentially finishes passing through the fixing rollers 15, the first sheet discharge rollers 16, and the second sheet discharge rollers 17.

In the example shown in FIG. 8, it is assumed that a jam occurs at the position of the fixing rollers 15. That is, in the example shown in FIG. 8, the target roller is the fixing roller 15 shaded in the drawing. A check is made to determine whether a jam has occurred and the jam type Jk, in accordance with a change in the q-axis current value Iq of the fixing motor 3b that rotationally drives the fixing rollers 15.

Changes in the q-axis current value Iq are monitored during the period (an expected passage period) during which the sheet 5 is expected to pass through the fixing roller 15, and this expected passage period is determined from the time elapsed since the reference time when the sheet 5 arrived at the reference position located on the upstream side of the fixing rollers 15. In FIG. 8, the reference position is set as the position (detection position) at which the registration sensor 61 is disposed, and the reference time is set at time t10 at which the registration sensor 61 is switched on. Time t15 at which a set period T15 has passed since time t10 is set as the start time of the expected passage period.

The set period T15 is the period of time required for the sheet 5 to be conveyed over the distance from the position of the registration sensor 61 to the fixing rollers 15, and is determined by taking into account variation of the conveyance speed. The set period T15 is stored as part of control data.

In a case where the amount of change Δ in the q-axis current value Iq is equal to or smaller than a predetermined threshold value th15 even after time t15 at which the top edge of the sheet 5 arrives at the fixing rollers 15, the jam determiner 202 determines that an accordion jam (see FIG. 3A) has occurred before the fixing rollers 15. The amount of change Δ is the difference between the q-axis current value Iq before (or immediately before, for example) time t15 and the q-axis current value Iq after time t15. The amount of change Δ is periodically obtained during a predetermined monitoring period Tm after time t15, and jam determination is performed by comparing the greatest value or the mean value during the monitoring period Tm with the threshold value th15.

The threshold value th15 is determined as follows: sheets of various kinds are made to enter the nip portion between the fixing rollers 15, and the amounts of changes in the load torque to be applied to the main motor 3a are measured in an experiment. The smallest value of the amounts of changes in the load torque during normal conveyance is converted into a q-axis current value Iq, and the obtained q-axis current value Iq is set as the threshold value th15.

Time t150 at which it is determined that an accordion jam has occurred is earlier than time t20 at which the sheet discharge sensor 62 is expected to be switched on. In other words, an occurrence of a jam can be detected earlier than in a case where whether a jam has occurred is detected in accordance with an output of the sheet discharge sensor 62. Accordingly, it is possible to stop the conveyance at an earlier stage and to prevent progress of the jam.

In a case where the q-axis current value Iq increases to exceed the threshold value th15 at time t15, and the q-axis current value Iq starts changing after a period T151 (equivalent to the time required for the fixing rollers 15 to make one revolution) has passed since time t15, the jam determiner 202 determines that a winding jam (see FIG. 3B) has occurred.

In this case, time t151 at which it is determined that a winding jam has occurred is earlier than time t20 at which the sheet discharge sensor 62 is expected to be switched on. Accordingly, the conveyance can be stopped earlier than in a case where whether a jam has occurred is detected in accordance with an output of the sheet discharge sensor 62.

As the type of each jam is determined in this manner, the jam occurrence position can be identified more accurately than in conventional cases. In other words, as a jam is determined to be an accordion jam, a location before the fixing rollers 15, or more specifically, a location near the upstream side of the nip portion between the fixing rollers 15 is identified as the jam occurrence position. As a jam is determined to be a winding jam, the peripheral surface of a fixing roller 15 is identified as the jam occurrence position. In conventional cases, it is not possible to identify such accurate occurrence positions.

In the example shown in FIGS. 9A and 9B, it is assumed that a jam occurs at the position of the secondary transfer rollers 14. In the example shown in FIGS. 9A and 9B, the target roller is the secondary transfer roller 14 shaded in the drawing. A check is made to determine whether a jam has occurred and the jam type Jk, in accordance with a change in the q-axis current value Iq of the main motor 3a that rotationally drives the secondary transfer rollers 14.

Changes in the q-axis current value Iq are monitored during the period (an expected passage period) during which a sheet 5 is expected to pass through the secondary transfer rollers 14. The expected passage period is determined from the time elapsed since the reference time at which the sheet 5 arrived at the reference position located on the upstream side of the secondary transfer rollers 14. The reference position is set as the detection position at which a sheet 5 is detected by the registration sensor 61 as in the example shown in FIG. 8, and the reference time is set at time t10 at which the registration sensor 61 is switched on. Time t14 at which a set period T14 has passed since time t10 is set as the start time of the expected passage period.

The set period T14 is the period of time required for the sheet 5 to be conveyed over the distance from the position of detection of the sheet 5 by the registration sensor 61 to the secondary transfer rollers 14, and includes the time for the sheet 5 to stand by before the registration rollers 13 for skew correction and registration. The set period T14 is determined in the same manner as the above mentioned set period T15, and is stored in advance.

In a case where the amount of change Δ in the q-axis current value Iq is equal to or smaller than a predetermined threshold value th14 even after time t14 at which the top edge of the sheet 5 arrives at the secondary transfer rollers 14, the jam determiner 202 determines that an accordion jam (see FIG. 3C) has occurred before the secondary transfer rollers 14. The amount of change Δ is periodically obtained during a predetermined monitoring period Tm after time t14, and jam determination is performed by comparing the greatest value or the mean value during the monitoring period Tm with the threshold value th14. The threshold value th14 is determined in accordance with the same experiment as that for the above mentioned threshold value th15.

Time t140 at which it is determined that an accordion jam has occurred is earlier than time t100 at which the registration sensor 61 is expected to be switched from an OFF-state to an ON-state. In other words, an occurrence of a jam can be detected earlier than in a case where a jam occurrence is detected if a sheet 5 does not finish passing through the registration sensor 61 even after time t100, in accordance with an output of the registration sensor 61.

In a case where the q-axis current value Iq increases to exceed the threshold value th14 at time t14, and the q-axis current value Iq starts changing after a period T142 (equivalent to the time required for the secondary transfer rollers 14 to make one revolution) has passed since time t14, the jam determiner 202 determines that a winding jam has occurred as the sheet 5 winds around the secondary transfer roller 14.

In a case where the q-axis current value Iq increases to exceed the threshold value th14 at time t14, and the q-axis current value Iq starts changing before the period T142 has passed since time t15, the jam determiner 202 determines that a winding jam has occurred as the sheet 5 winds around the intermediate transfer belt 18 (see FIG. 3D).

If the q-axis current value Iq hardly changes but stays in the same manner as during normal conveyance as shown in FIG. 9B even though the sheet 5 winds around the intermediate transfer belt 18, for example, it is possible to determine that a jam has occurred at the position of the secondary transfer rollers 14 at time t150. That is, a smaller threshold value th150 than the threshold value th15 is prepared, and, in a case where the amount of change Δ in the q-axis current value Iq of the fixing motor 3b after time t15 is equal to or smaller than the threshold value th150, it is determined that a winding jam has occurred at the position of the secondary transfer rollers 14.

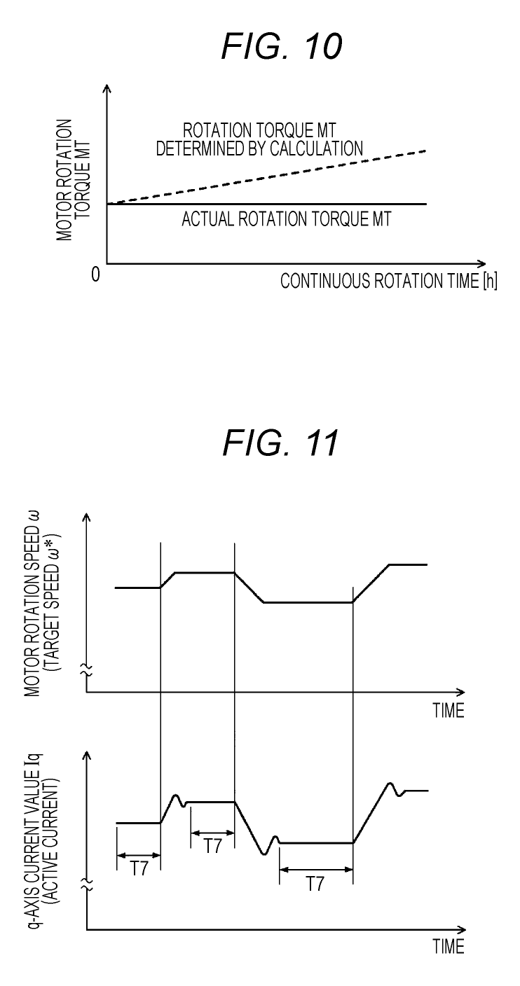

FIG. 10 shows torque calculation error due to continuous rotation.

As described above, whether a jam has occurred is determined in accordance with a change in the q-axis current value Iq. The threshold values th14 and th15 to be used in the determination are calculated by converting the rotation torque MT of the motor 3 into the q-axis current value Iq according to the following equation.

MT=K·Iq (K: constant)

The constant K in this equation includes an interlinkage magnetic flux φ that is a temperature-dependent parameter. The temperature of the windings 33 through 35 rises as the continuous rotation time of the motor 3 becomes longer. Because of this, a difference (error) is generated between the rotational torque MT calculated by calculation based on the q-axis current value Iq and the actual rotation torque MT, as shown in FIG. 10.

To more accurately determine a change in the q-axis current value Iq as a change in the load to be applied to the motor 3, it is desirable to correct the q-axis current value Iq or the threshold values th14 and th15 in accordance with the temperature of the motor 3.

In view of this, the jam determiner 202 corrects the amount of change Δ and/or the thresholds th14 and th15 in accordance with the temperature of the motor 3 so that the change in the q-axis current value Iq matches the change in the torque on the rotation axis of the motor 3. In doing so, the jam determiner 202 refers to the data indicating the correspondence between the temperature of the motor 3 and the continuous rotation time of the motor 3, and determines the temperature in accordance with the continuous rotation time of the motor 3.

FIG. 11 shows the periods during which the current flowing in the motor 3 is measured in a case where speed is adjusted during conveyance.

The peripheral speed of the fixing rollers 15 varies with expansion and contraction of the roller diameter due to temperature adjustment. There is a case where the rotation speed of the fixing motor 3b is adjusted during conveyance so that the conveyance speed becomes the same between the secondary transfer position and the fixing position. That is, the conveyance controller 201 appropriately changes the target speed ω* to be supplied to the vector controller 25b.

When the target speed ω* is changed, the q-axis current value Iq changes due to excess or deficiency of response in vector control. This change does not indicate a change in the load on the fixing motor 3b. Therefore, in the constant speed period T7 in which the rotation speed of the fixing motor 3b is kept constant, the jam determiner 202 determines whether a jam has occurred and the jam type Jk, in accordance with a change in the q-axis current value Iq of the fixing motor 3b.

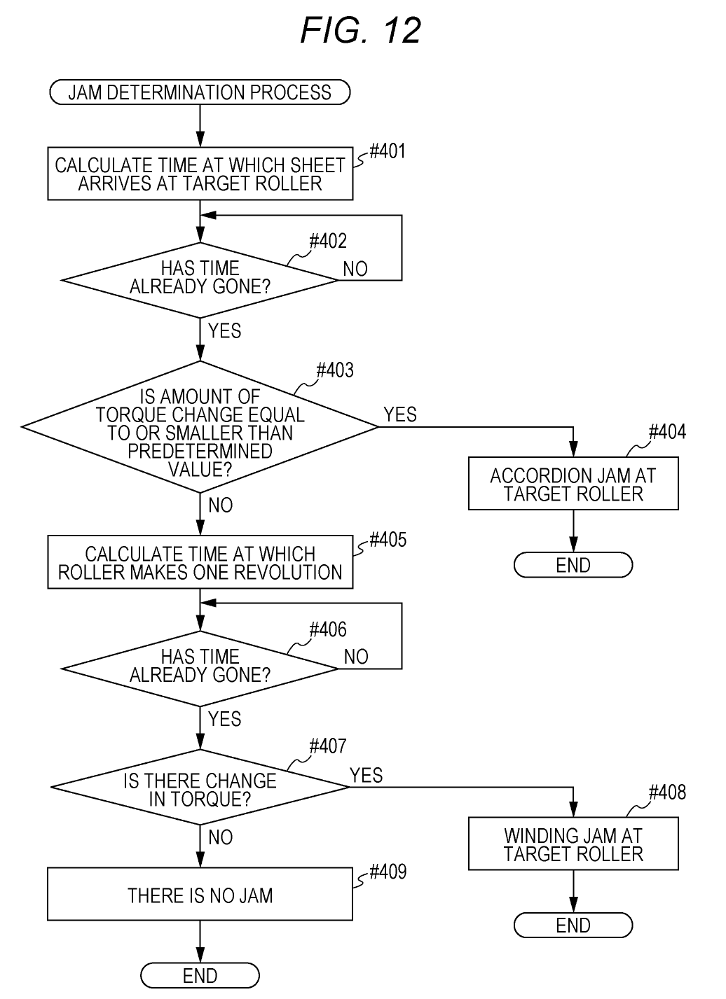

FIG. 12 shows the flow in a jam determination process in the image forming apparatus 1.

When a sheet 5 arrives at the reference position, the set period T14 or T15 is added to the arrival time, so that time t14 or time t15 at which the sheet 5 arrives at the target roller is calculated (#401).

When time t14 or t15 comes (YES in #402), a check is made to determine whether the amount of change in the rotation torque MT is equal to or smaller than a predetermined value, in accordance with the q-axis current value Iq (#403). If the amount of change in the rotation torque MT is equal to or smaller than the predetermined value (YES in #403), it is determined that an accordion jam has occurred at the position of a target roller (#404).

If the amount of change in the rotation torque MT is larger than the predetermined value (NO in #403), the time at which the target roller makes one revolution is calculated in accordance with the reduction ratio between the motor 3 and the target roller and the rotation speed of the motor 3 (#405).

After the time has gone (YES in #406), if the rotation torque MT varies (YES in #407), it is determined that a winding jam has occurred at the position of the target roller (#408). If the rotation torque MT does not vary (NO in #407), it is determined that no jam has occurred (#409).

According to the above embodiment, it is possible to determine whether a jam has occurred and the jam type at the position of a roller not provided with any sensor component that detects the presence/absence of a sheet 5.

The q-axis current value Iq indicates the magnitude of the q-axis current component that increases and decreases the rotation torque MT so that the rotation speed of the motor 3 is kept at the target speed (ω*), in accordance with a change in the load torque to be applied to the motor 3. The q-axis current component is included in the current (motor current) flowing from the DC power supply line 260 to the motor 3. From the q-axis current component that is a component obtained by excluding the d-axis current component from the motor current, it is possible to detect a change in the load torque on the motor 3 more accurately than in a case where a change in the load torque is detected from the motor current including the d-axis current component. Thus, the type of jam can be determined with accuracy suitable for practical use.

According to the embodiment described above, there is no need to prepare a heat-resistant sheet sensor in the vicinity of the fixing rollers 15, and there is no need to prepare a noncontact-type (reflective) sheet sensor that detects the presence/absence of a sheet 5 in the vicinity of the secondary transfer rollers 14, without applying any stress to the sheet 5. Thus, the component costs of the image forming apparatus 1 can be lowered.

In the embodiment described above, the reference time in a case where whether a jam has occurred at the position of the fixing rollers 15 is determined may be the time at which a jam is detected in accordance with a change in the q-axis current value Iq of the main motor 3a that rotationally drives the upstream-side rollers (11 through 14) disposed on the upstream side of the fixing rollers 15. In that case, the reference position is a position at which an upstream-side roller is disposed.

In the embodiment described above, in a case where the q-axis current value Iq increases to exceed the threshold value th14 at time t14, and any sheet 5 is not detected by the sheet discharge sensor 62 after time t20 at which the sheet 5 is expected to arrive at the position of the sheet discharge sensor 62 after time t14, it is possible to determine that a winding jam has occurred as the sheet 5 winds around a secondary transfer roller 14 or the intermediate transfer belt 18.

Further, the configurations of the entire image forming apparatus 1 and the respective components, the contents of the processes, the sequence or time of the processes, the configuration of the motor 3, the threshold values th14 and th15, and the like may be modified as appropriate within the scope of the present invention.

According to an embodiment of the present invention, it is possible to determine whether a jam has occurred and a jam type at the position of a roller not provided with any sensor component, and thus reduce the size and the cost of the apparatus.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that conveys a sheet and forms an image on the sheet, the image forming apparatus comprising:
a plurality of rollers that are arranged at different positions from one another in a conveyance path of the sheet, and convey the sheet;
a motor that rotationally drives at least one of the rollers;
a drive that drives the motor by applying a current to the motor; and
a hardware processor that determines whether a jam has occurred and a jam type, in accordance with a change in the current flowing in the motor in a period during which the sheet is expected to pass through a target roller being rotationally driven by the motor among the rollers.

2. The image forming apparatus according to claim 1, wherein
the motor is a permanent magnet synchronous motor,
the image forming apparatus further comprises a motor controller that performs vector control on driving of the motor, and
the hardware processor determines whether a jam has occurred and a jam type, in accordance with a change in the current flowing in the motor, the current flowing in the motor being an active current that is a current component generating a rotation torque in the motor in the vector control.

3. The image forming apparatus according to claim 1, wherein, when an amount of the change in the current is not larger than a predetermined value even after a time at which a top edge of the sheet arrives at the target roller, the hardware processor determines that an accordion jam has occurred before the target roller.

4. The image forming apparatus according to claim 3, wherein, when the current increases to exceed the predetermined value at the time, and the current starts changing after a period required for the target roller to make one revolution has passed since the time, the hardware processor determines that a winding jam has occurred as the sheet winds around the target roller.

5. The image forming apparatus according to claim 3, wherein
a sensor that detects presence/absence of the sheet is disposed on a downstream side of the target roller, and
when the current increases to exceed the predetermined value at the time, and the sheet is not detected by the sensor after a time at which the sheet is expected to arrive at a position at which the sensor is disposed, the hardware processor determines that a winding jam has occurred as the sheet winds around the target roller.

6. The image forming apparatus according to claim 1, wherein the period during which the sheet is expected to pass through the target roller is determined from a period of time elapsed since a reference time at which the sheet arrived at a reference position located on an upstream side of the target roller.

7. The image forming apparatus according to claim 6, wherein the reference time is a time at which the sheet is detected by a sensor that detects presence/absence of the sheet at the reference position.

8. The image forming apparatus according to claim 6, wherein the reference time is sensed in accordance with a change in a current flowing in a motor that rotationally drives an upstream-side roller disposed at the reference position.

9. The image forming apparatus according to claim 3, wherein at least one of the amount of change and the predetermined value is corrected in accordance with temperature of the motor, to adjust the change in the current flowing in the motor to a change in torque on a rotation axis of the motor.

10. The image forming apparatus according to claim 1, wherein, when speed control for adjusting a rotation speed of the motor is performed during conveyance of the sheet, the hardware processor determines whether a jam has occurred and a jam type, in accordance with a change in a current flowing in the motor in a constant speed period during which the rotation speed of the motor is maintained at a constant speed.

11. The image forming apparatus according to claim 1, wherein
the motor is a drive source shared among the rollers, and
the hardware processor determines whether a jam has occurred, a jam type, and a jam occurrence position, using a threshold value for determination, the threshold value being set for each of the rollers.
